(19) United States
(12) Patent Application Publication
(10) Pub. No.: US 2018/0033002 A1
(43) Pub. Date: Feb. 1, 2018

(54) MULTI-USE TOKEN WITHIN A MOBILE DOCUMENT

(71) Applicant: NCR Corporation, Law Dept., Duluth, GA (US)

(72) Inventors: Richard A. Weiss, McKinney, TX (US); Robert Thomas Borucki, Mesa, AZ (US)

(21) Appl. No.: 15/219,878

(22) Filed: Jul. 26, 2016

(51) Int. Cl. G06Q 20/36; G06Q 20/32; H04W 4/00

(52) U.S. Cl. CPC G06Q 20/3672; H04W 4/008; G06Q 20/327; G06Q 20/3274

(57) ABSTRACT

Some embodiments herein include at least one of systems and methods for multi-use tokens within a mobile document. One such embodiment includes generating a mobile document having a token that uniquely identifies a user account and transmitting the mobile document to a requestor for conducting at least two transactions with at least one entity through the token. Other embodiments herein include at least one of systems and methods for providing a token, such as in a mobile document, to an app on a mobile device and then identifying data based upon a purpose for which the token is presented by the app on the mobile device.

### BACKGROUND INFORMATION

Consumers have the option to receive coupons, tickets, vouchers, and passes, such as a parking pass, as or with barcodes on their mobile devices. These mobile barcodes provide convenience to the consumer. Various mobile apps may provide access to mobile barcodes, such as private label mobile apps of retailers and service providers that include wallet-like functionality, as well as dedicated mobile wallet apps. A wallet is a mobile application or functionality included within a mobile app that enables mobile tickets, mobile documents, coupons, vouchers, and the like to be delivered and stored locally on the device itself. This device repository enables items to be located easily on a mobile device and opened-up for scanning without requiring a data connection. Travelers in locations where data connections are unavailable or inconvenient may prefer the wallet functionality for its ability to store barcodes onboard for convenient retrieval. At the same time, images of such items may also be stored, such as within text messages, emails, a photo app, or otherwise on a mobile device. Further, most barcoded items are for a one-time use for a specific purpose at a single location.

While consumers often may readily obtain a copy of a needed mobile barcoded item, wireless service may not always be available, response time may be slow, and passwords needed to access thereto may be easily forgotten. In addition, stored, mobile devices (e.g., mobile wallets included thereon) can become cluttered with items including mobile barcodes that consumers may need at different locations for different purposes. Thus, current mobile solutions for tickets, passes, vouchers, loyalty cards, and the like are cumbersome, can be unreliable when wireless service is unavailable, require obtaining a new or updated barcoded item for each purpose and location, and make locating a desired item on a mobile device difficult.

These and other problems can be solved, without limitation, but the following embodiments.

### SUMMARY

Various embodiments herein each include at least one of systems and methods for multi-use tokens, for example presented in a barcode, included within a mobile document. Tokens are data items that uniquely identify a customer account, such as a frequent flyer account, a retailer or restaurant loyalty account, a movie theater or other venue operator account, a boarding pass associated with an account, and the like. These various embodiments provide solutions to provide a single mobile document to a customer with a token that is associated with accounts of a customer with more than one retailer or service provider such that the single mobile document can be utilized at multiple retailers and service providers. Some such embodiments further include dynamic elements within a mobile document thereby providing a mobile document that may be updated over time for various purposes. Note however that mobile documents may be of a type that cannot be updated, or if updatable, the mobile documents need not be updated, thereby remaining static.

One such embodiment in the form of a method includes storing in a database, a user account with a token uniquely identifying the user account, the user account associated with at least one retailer or service provider. The method further includes receiving, via a network from a mobile device, a mobile document request associated with the user account and generating a mobile document based on data retrieved from the database for the user account, the retrieved data including the token uniquely identifying the user account. The method may then transmit, via the network, the mobile document to the mobile device, the token included in the mobile document to be provided by the mobile device at the at least one retailer or service provider to associate transactions with the user account.

Another method embodiment includes receiving, via a network from at least one operator system data source, a mobile document generation request. The mobile document generation request includes at least one data item to be included in the mobile document when generated and to uniquely identify a user account with at least two operator system data sources. The request may also include one or both of data identifying a transmission mode for transmitting the mobile document to be generated and a network identifier of where to send the generated mobile document. This method then stores data of the mobile document generation request in a database and generates the mobile document including the at least one data item and metadata defining the at least one data item as a dynamic data item within the generated mobile document. This method then proceeds by transmitting, via the network, the generated mobile document according to the identified transmission mode to a network destination of the network identifier.

A further embodiment is in the form of a system. This system includes at least one computer processor, at least one memory device, at least one network interface device and a database under management by a database management system stored on the at least one memory device or accessible via that at least one network interface device. The database stores at least mobile document data received from at least two operator system data sources. The system further includes a mobile document generation module stored in the at least one memory device and executable by the at least one processor to perform data processing activities. The data processing activities of the mobile document generation module include receiving, via a network from one of the at least two operator system data sources, a mobile document generation request. The mobile document generation request includes data at least one data item to be included in the mobile document when generated and to uniquely identify a user account with the at least two operator system data sources. The data processing activities of the mobile document generation module may further include storing data of the mobile document generation request in a database. The data processing activities may also include generating the mobile document including the at least one data item and metadata defining the at least one data item as a dynamic data item within the generated mobile document. The data processing activities may additionally include transmitting, via the network, the generated mobile document according to a transmission mode identified with the received to a network destination of the network identifier.

### BRIEF DESCRIPTION OF THE DRAWINGS

FIG. 1 illustrates a mobile document, according to an example embodiment.

FIG. 2 is a logical block diagram of a system architecture, according to an example embodiment.

FIG. 3 is a block diagram of a computing device, according to an example embodiment.

FIG. 4 includes three process flow diagrams, according to example embodiments.

FIG. 5 is a block flow diagram of a method, according to an example embodiment.

FIG. 6 is a block flow diagram of a method, according to an example embodiment.

FIG. 7 is a block flow diagram of a method, according to an example embodiment.

### DETAILED DESCRIPTION

Today, mobile documents, such as airline boarding passes and event tickets include barcodes that are scanned to permit entry and are typically used only once. For example, to check in at an airport, to go to a movie, or for staging a transaction. This means that every time an individual is engaged in one of those activities and uses a mobile barcode, they have to go through the process of requesting and receiving a new mobile document with a new mobile barcode and having it readily accessible or obtaining an updated mobile document with an updated mobile barcode when a flight changes, a ticketed event is postponed, and the like. In addition, mobile barcodes included in mobile documents do not provide a capability for learning information about the user to enable the user to engage in other transactions with the same mobile barcode. Further, current mobile barcodes do not provide abilities to retailers and service providers to obtain information based on a person's desires, activities, trends, and habits through repeated usage of a single barcode for multiple purposes, at multiple locations.

Various embodiments herein enable each of he problems identified above, and others, to be resolved. First, the various embodiments enable a user to use the same mobile barcode for multiple transactions, even at different retailers and service providers, such as restaurants, stores, event venues such as stadiums, arenas, movie theaters, and the like. Second, the various embodiments allow information to be learned about the user, such as desires, activities, trends, and habits, by enabling the user to engage in other transactions with the same barcode of a single mobile document. The embodiments herein show how this accomplished, including how the gathered information can be obtained and provided to others to enable them to provide relevant transaction opportunities, offers, and information.

For example, let's suppose an individual buys a ticket, obtains a mobile barcode, presents it at the movie theater, and is then let in. The next time the individual purchases a ticket, the same mobile barcode may be presented, but the original mobile barcode links back to an account associated with the individual, and when the individual has the mobile barcode scanned, the system confirm that a ticket was indeed purchased, and the individual is admitted to the theater. Next the individual may present the same mobile barcode at a concession stand to obtain loyalty points and discounts. The individual's purchase of popcorn and a particular beverage type may be tracked and a discount or promotion may be automatically applied and loyalty points gained. Meanwhile, the system collects information related to the individual's movie habits and concession purchases, such as the individual likes mostly Sci-Fi and typically purchases a medium popcorn with a large cola beverage. As a result, when a new Sci-Fi movie is about to come out, the theater informs the user, and can even ask if the individual wants to buy a ticket and can be set up for the individual to buy the ticket, possibly at a discount, as well as an additional discount for a medium popcorn and large cola beverage. The system can also keep track of what time of day the individual goes to the theater. If the individual typically goes to matinees, the system can entice the individual to go to later showings, which typically cost more, but provide a discount or a free medium popcorn and large cola beverage to encourage the change in the individual's habits and create the prospect of more revenue.

Furthermore, in sonic embodiments, the system can share relevant information with the individual about local restaurants in the area so that they might go before or after the movie. Or, the system can share information about when the individual will be going to the theater, e.g., at a 4:00 pm showing, and the restaurant, or the system on the restaurant's behalf, can send the individual one or both of a reservation offer and a promotion for that restaurant. Such restaurant and other such promotions provide revenue opportunities for operators of systems of such embodiments and restaurants and other retailers and service providers may pay for the promotion to be provided or a portion of sales resulting from use of the promotion.

Further, some embodiments can alter the information displayed on a mobile device within a mobile document, along with the original mobile barcode in the event the mobile barcode happens to be updated without user interaction such as in the background, so as to provide relevant and timely information for a subsequent transaction. In this way, the user still receives only one initial mobile ticket including a barcode, but the mobile document of the mobile ticket including the barcode is kept current by displaying updated information. The ability to update a mobile document and information presented thereon, which may include a mobile barcode, makes the mobile document dynamic. Thus, such mobile documents that may be updated are referred to herein as dynamic mobile document in some instances herein. Using the above example, the movie theater patron who buys a second movie ticket would see the new movie title, date, auditorium location, and show-time displayed on their mobile ticket. The digital contents of the barcode need not change in order for this to occur. In this way, the user is constantly presented with relevant and meaningful information in a convenient fashion. without the need to sort through multiple mobile barcoded ticket documents to locate the desired one.

The various embodiments can be used in any environment in which a mobile barcode is or could be used, including with respect to an event (including to purchase items from a mobile device and have them delivered to a restaurant table, to a seat or suite during a game at a ballpark) or a boarding pass (including the local restaurant features described above), for example, for multiple uses.

In some such embodiments, a mobile barcode is but one embodiment. However, the barcode is simply encoded with data including a data item used to identify the user and to communicate that data item to another system via a barcode scanner. The system may also use other means of communicating token identification information including BLUETOOTH®, WI-FI®, Near-Field Communication (NFC), and other wireless communications. Thus, the term “token” is used in describing some embodiments herein to refer to an identifier of an account of an individual, which essentially identifies the individual who owns the account. The account may be an account of a retailer or service provider and other such accounts that an individual may have established with a retailer or service provider.

These and other embodiments are described herein with reference to the figures.

In the following detailed description, reference is made to the accompanying drawings that form a part hereof, and in which is shown by way of illustration specific embodiments in which the inventive subject matter may be practiced.

The functions or algorithms described herein are implemented in hardware, software or a combination of hardware and software. The software comprises computer executable instructions stored on computer readable media such as memory or other type of storage devices. Further, described functions may correspond to modules, which may be hardware, software, firmware, or any combination. thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

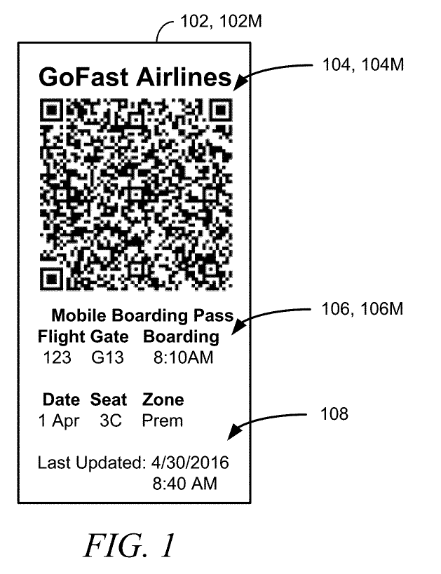

FIG. 1 illustrates a mobile document 102, according to an example embodiment. The mobile document 102 is one example embodiment of a dynamic mobile document as also referred to herein. The illustrated mobile document 102 is an airline boarding pass that may be used to gain entry to a flight, pass through airport security, gain entry to an airline lounge, and other possible uses. The mobile document 102 is a mobile document that may be received on a mobile device and viewed within a mobile app, such as an airline mobile app or a generic mobile wallet app such as the “WALLET” app on IPHONE® devices available from APPLE, INC. of Cupertino, Calif. and other apps that perform similar functions to provide ready access to items such as credit cards, travel service boarding passes, loyalty cards, membership cards, event tickets, and the like. Regardless of the actual mobile app that is used, the mobile app may contain functionality natively or as augmented or extended in some embodiments or augmented with the functionality of one or more other apps in sonic embodiments to facilitate some of the various embodiments herein.

Although illustrated as an airline boarding pass, the mobile document in other embodiments may be a ticket to gain entry to an event such as a concert, a movie theater, a sporting event, and the like. The mobile document 102 may also instead be a customer loyalty account card, a coupon, a frequent diner card for a restaurant, a membership card for an automobile association, a queued service number identifier for service at a counter such as at the department of motor vehicles, and the like. Further, some mobile documents 102 may be multipurpose including a plurality of two or more information items, such as a boarding pass, a coupon for an airport restaurant and loyalty card for the restaurant, a rental car loyalty card, and the like all within the single mobile document.

Further note that although the mobile document 102 is illustrated in FIG. 1 as including a barcode 104, the mobile document 102 may also or instead include underlying data, that is riot presented, including data that is utilized when the token is to be provided by a wireless transceiver of a mobile device to identify the user. The wireless transceiver may be a Near-Field Communication (NFC) device, a BLUETOOTH® device, a WI-FI device, and other such transceiver devices that communicate data including the token, such as in a tap-to-pay scenario that is becoming more common in modern commerce. Thus, in the mobile document 102 may be presented in various embodiments as a scanable barcode 104 or as a toke communicated as data via a wireless transceiver of a mobile device.

In some embodiments, the mobile document 102 is received and viewable within a specific mobile app, such as a mobile app of an airline, movie theater operator, sporting league, event venue, event ticket retailer, and other such apps. In some further embodiments, the mobile document 102 may be viewed within more than one mobile app, within a document viewing app, within an image viewing app, within an email or text message, and the like.

The mobile document 102 includes several elements, some of which may be dynamic. As noted above, a dynamic mobile document is a mobile document that includes one or more elements that may be updated after the mobile document is first generated and provided to a mobile device. The elements that may be updated may be referred to as dynamic elements. One element of the mobile document 102 is the “GoFast Airlines” header or logo. While the header or logo may be updated, such elements are typically static. There are also three dynamic elements 104, 106, 108 of the mobile document 102, although other mobile documents may include only one dynamic element, many dynamic elements, or no dynamic elements. As illustrated in FIG. 1, the dynamic elements of the mobile document 102 include a barcode 104, flight information 106, and an indicator 108 of when the mobile document 102, or one or more ©f the dynamic elements therein, was last updated. In some embodiments, the indicator 108 may not be visible, but instead utilized by an update process of a mobile wallet app to determine when to check for updates (e.g., each time the mobile wallet app is opened or the mobile document 102 is viewed) to the mobile document 102, such as every fifteen minutes, every two hours, daily, or another period. The refresh period for the mobile document 102 may be specified within a mobile wallet or other app used to view the mobile document 102, within metadata 102M of the mobile document, within metadata 1041, 106M of one or more dynamic elements 104, 106, or multiple such locations. Regardless, the dynamic elements 104, 106 are data items that can change over time while the mobile document 102 resides on a mobile device.

Mobile documents 102, such as travel boarding passes as illustrated or movie tickets, sporting event tickets, and the like, often involve underlying data that may change. Such data that may change in various embodiments may include airport gate assignments, flight status, boarding times, sporting event start times (e.g., changes due to weather delays), seat assignments, theater complex theater assignments, and the like. In some embodiments, such as when the mobile document 102 is a movie theater ticket, the operator of the movie theater can utilize the dynamic nature of the mobile document 102 to inform customers of a venue change, such as to a different theater number or even a different location. This can be useful in many scenarios such as when a scheduled theater has technical problems, moving a movie showing to a smaller or larger theater based on a number of tickets sold, or even to a different location to load balance theater traffic is higher in scheduled location than the newly scheduled location. In an embodiment where the mobile document 102 is for an outdoor sporting event, the dynamic nature of the mobile document 102 can also be utilized to rapid notify ticket holders of weather delays and postponements.

The various embodiments herein allow for the dynamic elements 104, 106 to be updated or for the entire mobile document 102 to be updated. The updates may occur in different embodiments in different ways. For example, a mobile wallet app may include code that operates to refresh data of dynamic elements 104, 106 by retrieving updated data from one or more data sources as identified within metadata 102M, 104M, 106M of a mobile document or as may be transmitted thereto. In other embodiments, one or more other apps may feed updated data to the mobile wallet app.

In some embodiments, metadata 102M, 104M, 106M underlies one or more of the mobile document 102 and dynamic elements 104, 106. The metadata may define how the data is to be presented, link the data of the respective dynamic element to a callable application programming interface (API), web service, or other network location from which an update to the respective data may be requested, set the refresh period, and other purposes. One or more of the metadata 102M, 104M, 106M items may include the token, as discussed above, that may be provided by a wireless transceiver of a presenting mobile device.

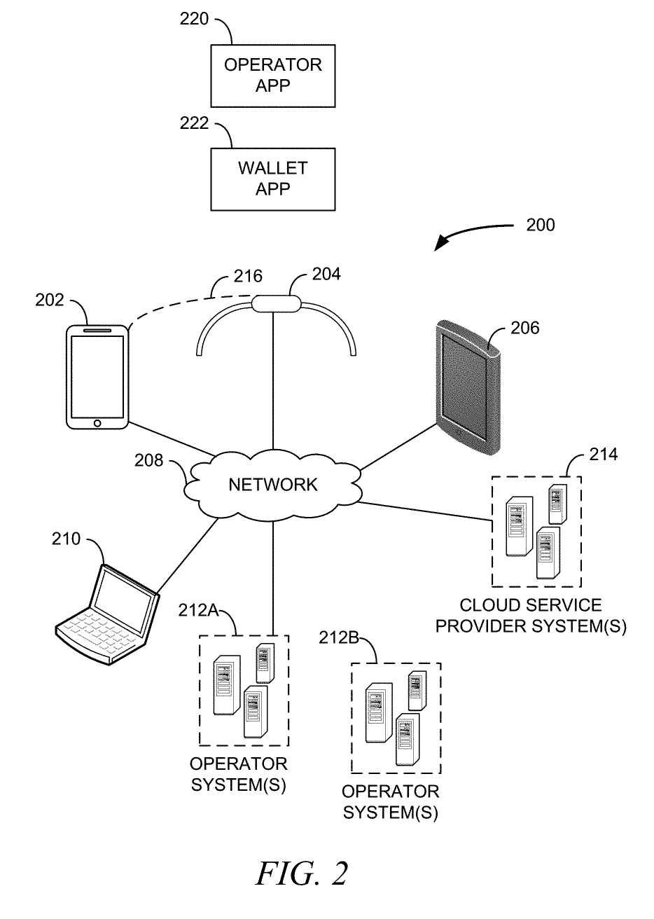

FIG. 2 is a logical block diagram of a system architecture 200, according to an example embodiment. The system architecture 200 may include one or more operator systems 212A, 212B, a cloud service provider system 214, and any number of consumer computing devices, such as one or both of personal computers 210 and mobile devices, such as smartphones 202, smartwatch 204, tablet 206, among others. These elements of the system architecture 200 are generally connected via one or more networks 208, which includes the Internet in many embodiments. Note that some mobile devices, such as the smartwatch 204. may not connect directly to the network 208 and instead connect via a BLUETOOTH® connection 216 to another device, such as the smartphone 202.

The operator systems 212A, 212B are examples of systems implemented by operators of services or facilities for which mobile documents, such as the mobile document 102 of FIG. 1, are provided. The operator systems 212A, 212B may therefore be a passenger flight reservation and operations system of an airline, a ticket purchasing and issuing system of a theater or venue operator, and the like. The operator systems 212A, 212B therefore are generally systems that maintain and generate data that is included in one or more mobile documents. The cloud service provider system 214 is a system that provides mobile document generation and update services to the operator systems 212A, 212B and to apps 220, 222 that are present on consumer devices. In some embodiments, the cloud service provider system 214 receives data from operator systems 212A, 212B to generate mobile documents and to transmit them to the consumer devices or return them to the operator systems 212A, 212B to provide them to the consumer devices. The cloud service provider system 214 may also provide updates to dynamic mobile documents when requested by the consumer devices directly or indirectly via the operator system 212.

The consumer devices 220, 222 may include one or both of an operator app 220 and a wallet app 222. Some embodiments may include a plurality of operator apps 220, The operator app 220 is a mobile device app that communicates over the network 208 with one or both of the operator systems 212A, 212B, and the cloud service provider system 214 to request and receive mobile documents. These mobile documents, in some embodiments, may be dynamic mobile documents with one or more dynamic elements that are updated with data received from the cloud service provider system 214. The operator app 220 may store and present mobile documents.

The operator app 220, in some embodiments, may also provide mobile documents to the wallet app 222 when such a wallet app 222 is present in the particular embodiment. The wallet app 222 may receive mobile documents and store and present them. Dynamic mobile documents, i.e., mobile documents including at least one dynamic element, may also be received via email, text message, and other electronic means in some embodiments which may then be imported to one or both of the operator app 220 and the wallet app 222. The operator app(s) 220 and the wallet app 222 may also request and receive dynamic element updates from one or both of the operator systems 212A, 212B and cloud service provider system 214. Note that some mobile documents may also include dynamic elements included in the mobile document with data sourced from other network 208 locations, such as flight gate assignments, boarding times, destination weather data, which may be requested and received from a weather service provider (not illustrated), destination guide data sources (not illustrated), advertising content providers (not illustrated), and other data sources. Such data sourced from other network 208 locations may be requested or retrieved based on one or more data elements of a dynamic mobile document, such as a location of a venue, a time of an event, a token identifying the dynamic mobile document holder, and the like. Note however that although a dynamic mobile document or dynamic element thereof may be defined as being dynamic, the mobile document or element may not actually ever be updated. Thus, a mobile document or element thereof being defined as dynamic does not mean an update actually occurs as the mobile document or element thereof may remain static.

Although the operator systems 212A, 212B and the cloud service provider system 214 are illustrated as separate and distinct systems, these systems may be combined into a single system in some embodiments. Further, in some embodiments, the cloud service provider system 214 is operated by a third-party and is a multi-tenant system providing services for a plurality of operator systems 212A, 212B. In other embodiments, the cloud service provider system 214 is operated by the same entity as one of the operator systems 212A, 212B.

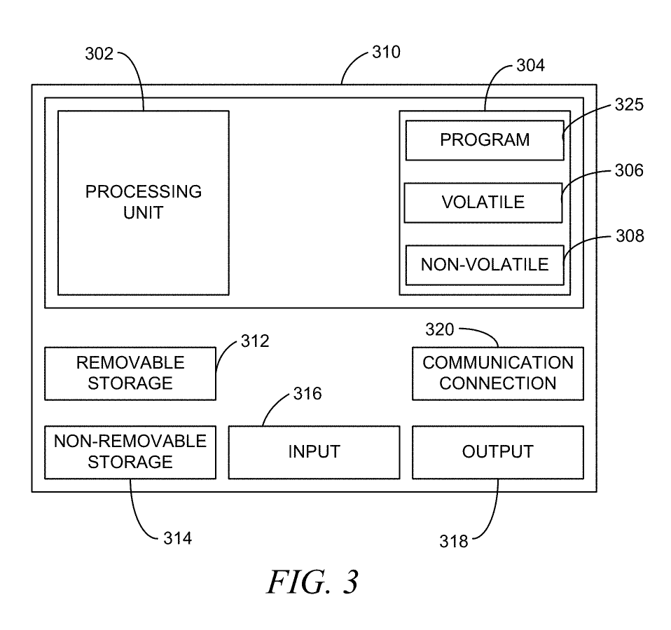

FIG. 3 is a block diagram of a computing device, according to an example embodiment. In one embodiment, multiple such computing devices are utilized in a distributed network to implement multiple components in a transaction-based environment. An object-oriented, service-oriented, or other architecture may be used to implement such functions and communicate between the multiple systems and components. One example computing device in the form of a computer 310, may include a processing unit 302, memory 304, removable storage 312, and non-removable storage 314. Although the example computing device is illustrated and described as computer 310, the computing device may be in different forms in different embodiments. For example, the computing device may instead be a smartphone, a tablet, smartwatch, or other computing device including the same or similar elements as illustrated and described with regard to FIG. 3. Devices such as smartphones, tablets, and smartwatches are generally collectively referred to as mobile devices. Further, although the various data storage elements are illustrated as part of the computer 310, the storage may also or alternatively include cloud-based storage accessible via a network, such as the Internet. Thus, the computer 310 may be included in several of these different forms in some embodiments, such as an operator system 212A, 212B, cloud service provider system 214, personal computers 210, smartphones 202, smartwatch 204, and tablet 206 of FIG. 2.

Returning to the computer :310, memory 304 may include volatile memory 306 and non-volatile memory 308. Computer 310 may include, or have access to a computing environment that includes, a variety of computer-readable media, such as volatile memory 306 and non-volatile memory 308, removable storage 312 and non-removable storage 314. Computer storage includes random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 310 may include or have access to a computing environment that includes input 316, output 318, and a communication connection 320. The input 316 may include one or more of a touchscreen, touchpad, mouse, keyboard, camera, one or more device-specific buttons, one or more sensors integrated within or coupled via wired or wireless data connections to the computer 310, and other input devices. The computer 310 may operate in a networked environment using a communication connection 320 to connect to one or more remote computers, such as database servers, web servers, and other computing device. An example remote computer may include a personal computer (PC), server, router, network PC, a peer device or other common network node, or the like. The communication connection 320 may be a network interface device such as one or both of an Ethernet card and a wireless card or circuit that may be connected to a network. The network may include one or more of a Local Area Network (LAN), a Wide Area Network (WAN), the Internet, and other networks. In some embodiments, the communication connection 320 may also or alternatively include a transceiver device, such as a BLUETOOTH® device that enables the computer 310 to wirelessly receive data from and transmit data to other BLUETOOTH® devices.

Computer-readable instructions stored on a computer-readable medium are executable by the processing unit 302 of the computer 310. A hard drive (magnetic disk or solid state), CD-ROM, and RAM are some examples of articles including a non-transitory computer-readable medium. For example, various computer programs 325 or apps, such as one or more applications and modules implementing one or more of the methods illustrated and described herein or an app or application that executes on a mobile device or is accessible via a web browser, may be stored on a non-transitory computer-readable medium.

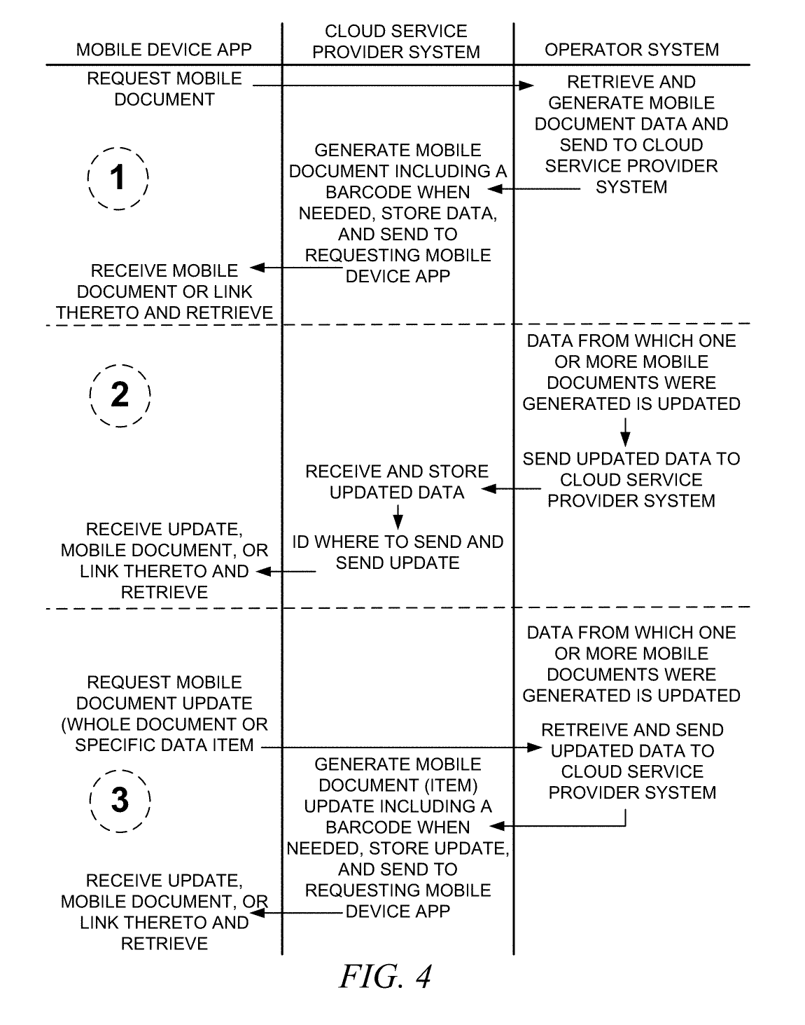

FIG. 4 includes three process flow diagrams 1, 2, and 3, according to example embodiments. The first process flow diagram 1 illustrates an example embodiment of a process whereby a mobile device app, such as the operator app 220 of FIG. 2, requests a mobile document from an operator system, such as the operator system 212A or 212B of FIG. 2. The process flow diagram 2 of FIG. 4 illustrates an example embodiment of a process through which the mobile device app receives an update to a mobile document pushed by the operator system. The process of flow diagram 3 illustrates an example embodiment of a process through which a mobile device app requests, or pulls, an update to a mobile document from the operator system, although in other embodiments, the request may instead be sent to a cloud service provider system, such as the cloud service provider system 214 of FIG. 2.

The first process flow diagram 1, as mentioned above, illustrates an example embodiment of a process whereby a mobile device app requests a mobile document from an operator system. The mobile device app sends a request for a mobile document to the operator system. The operator system then retrieves and generates data for the requested mobile document and sends the data to the cloud service provider system. The cloud service provider system then stores the mobile document data, generates the mobile document including a barcode (e.g., a Quick Response code, standard one-dimensional barcode) when needed for the document-type requested, and sends the generated mobile document to the requesting mobile device app. Note however that sending the mobile document to the mobile device app may include sending a link in an email, text message, in-app message, and the like or an image of the mobile document. In some embodiments, the cloud service provider system may return the generated mobile document to the operator system for relay back to the mobile device app.

The second process flow diagram 2, as mentioned above, illustrates an example embodiment of a process through which the mobile device app receives an update to a mobile document pushed by the operator system. Over time, data from which the mobile document was generated may change. For example, when the mobile document is an airline service boarding pass, the gate assignment for boarding of the flight may change on the operator system, such as 212A, 212B of FIG. 2. The operator system will send the updated data to the cloud service provider system, such as 214 of FIG. 2. The data sent to the cloud service provider system may not identify individual boarding passes to receive the update, but instead include sufficient data to identify the flight, such as a flight date, flight number, departure airport, and arrival airport plus a data representation of the newly assigned gate. As the cloud service provider system stores the data from which it generates the mobile documents are generated, the cloud service provider system is then able to identify to which mobile device app instances the mobile document has been sent within that data and then provide the update appropriately. Thus, when the cloud service provider system receives a data update from the operator system, the cloud service provider system stores the updated data, identifies to whom the update is to be provided when not specified in the received data, and generates and sends the update to one or more mobile devices apps, which as mentioned above may instead be text messages, entails, in-app messages, and the like.

The third process flow diagram 3 illustrates an example embodiment of a process through which a mobile device app requests, or pulls, an update to a mobile document from the operator system. This process flow begins with the mobile device app requesting an update to a mobile document, either as a whole or with regard to one or more specific dynamic elements included in the mobile document. The update request is sent to the operator system 212A, 212B. The operator system 212A, 21213 then retrieves the requested data when the data has been updated since the mobile document was generated and sends the data to the cloud service provider system. The cloud service provider system 214 then generates the mobile document update, stores the updated data, and sends the mobile document update to the mobile device app.

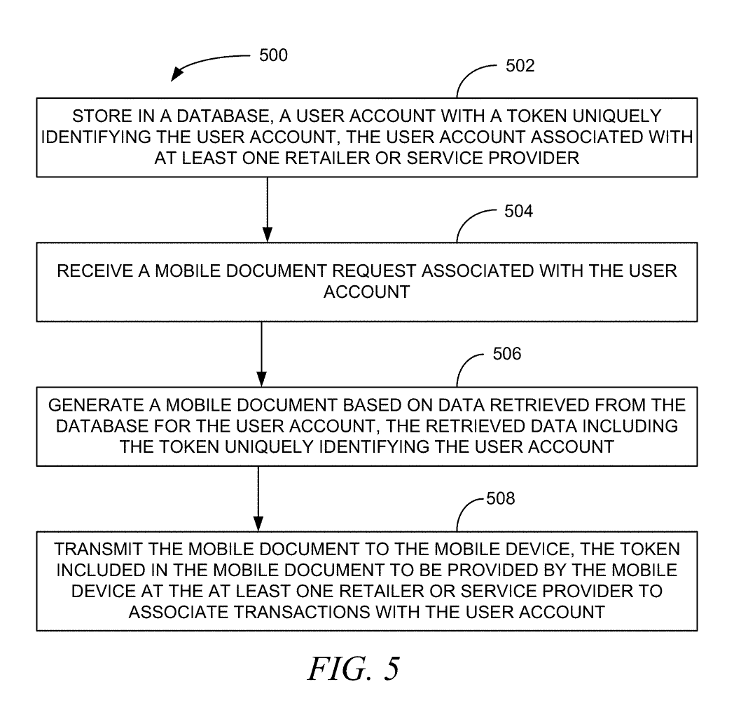

FIG. 5 is a block flow diagram of a method 500, according to an example embodiment. The method 500 is an example of a method that may be performed by one or both of the operator systems 212A, 212B of FIG. 2 to generate a mobile document and provide the mobile document to a mobile device.

The method 500 include storing 502 in a database, a user account with a token uniquely identifying the user account, the user account associated with at least one retailer or service provider. The token that uniquely identifies the user account may be one or more of a token assigned or generated by a system implementing the method 500, a token generated by a mobile document generation service operated by a third-party, such as on the cloud service provider system 214 of FIG. 2, or by another system operator, such as by another of the operator systems 212A, 212B to enable unique identification of the user account even when the token utilized by a user is a token generated or assigned by another entity. The token, in some embodiments, is a token that can be included in a single mobile document and used in multiple transactions with the at least one retailer or service provider. In some embodiments, the token may even be used in multiple transactions across two or more retailers and service providers.

The method 500 further includes receiving 504, via a network from a mobile device, a mobile document request associated with the user account and generating 506 a mobile document based on data retrieved from the database for the user account. The retrieved data may include the token uniquely identifying the user account. The method 500 then transmits 508, via the network, the mobile document to the mobile device. The token is included in the mobile document in some embodiments so that it can be provided by the mobile device at the at least one retailer or service provider during a transactions to associate transactions with the user account. Note that in some embodiments, transmitting 508 the mobile document to the mobile device includes transmitting 508 an in-app message with a link that may be selected to retrieve the mobile document on the mobile device when the in-app message is presented.

In some embodiments of the method 500 the at least one retailer or service provider includes at least two of a retailer, a restaurant, an event host, a movie theater operator, an event venue operator, and the like. The token in such embodiments, and as mentioned above, uniquely identifies the user account at each of the at least two of the retailer, the restaurant, the event host, and the service provider. The token may be included in the mobile document as a barcode, a data item that is transmitted, when used, by a radio transceiver device of the mobile device, such as BLUETOOTH®, NFC, WI-FI, and the like.

In some embodiments of the method 500, generating 506 and transmitting 508 the mobile document to the mobile device includes transmitting 508 the data retrieved from the database including data indicating how the mobile document is to be provided to the mobile device to a mobile document generation service. The mobile document generation service may then generate and transmit the mobile document to the mobile device. However, in other embodiments, the mobile document generation service may transmit the mobile document back to the system implementing the method 500 which then relays the mobile document back to the mobile device.

In some embodiments of the method 500, the data indicating how the mobile document is to be provided to the mobile device identifies at least one of a text message or email that includes a Uniform Resource Identifier from which the mobile document may be retrieved, a mobile device in-app message that includes the mobile document or a URI from which an app will retrieve the mobile document, an email that includes the mobile document therein or as an attachment. Regardless of the transmission mode, the mobile document is viewable within at least one of a mobile wallet app, a mobile app, a web browser, an image viewing app, and a document viewing app.

In some such embodiments, the method 500 further includes receiving, via the network from the mobile device, a mobile document data update request. The method 500 may then service the update request by retrieving at least a portion of the data for the mobile document from the database and transmitting at least the portion of the retrieved data for the mobile document to the mobile document generation service to provide to the mobile device. This updating may be performed by the mobile document generation service in some embodiments, while in other embodiments, the updating may instead be performed by the system implementing the method 500.

In some embodiments of the method 500, the mobile document is viewable within at least one of a mobile wallet app, a mobile app, a web browser, an image viewing app, and a document viewing app. The mobile document, in some embodiments, may include a dynamic event ticket portion identifying an event venue, event date, and event start time. The dynamic event ticket portion in such embodiments is to be presented at the venue via the token to gain entry to the venue for the event. In some such embodiments, the event venue, event date, and event start time are subject to change. Such embodiments of the method 500 may further include receiving, via the network from the mobile device, a mobile document data update request and retrieving any updates to at least one of the the event venue, event date, and event start time for the mobile document from the database. These embodiments then transmit, via the network to the mobile device, at least the portion of the retrieved data for the mobile document to update the mobile document on the mobile device.

In some embodiments of the method 500, the mobile document further includes a recommendation portion that provides recommendations of one or more other events, restaurants, products, promotions, and other retailers. The recommendation portion is populated in some embodiments by a recommendation process with data of at least one of promotional data, sponsored recommendations, recommendations determined based on historic data stored in association with the user account, proximity of restaurants and other retailers to the venue, and other data. The recommendation process may be process that executes on the system implementing the method 500, as part of the mobile document generation service, or as may be called across a network from another network location.

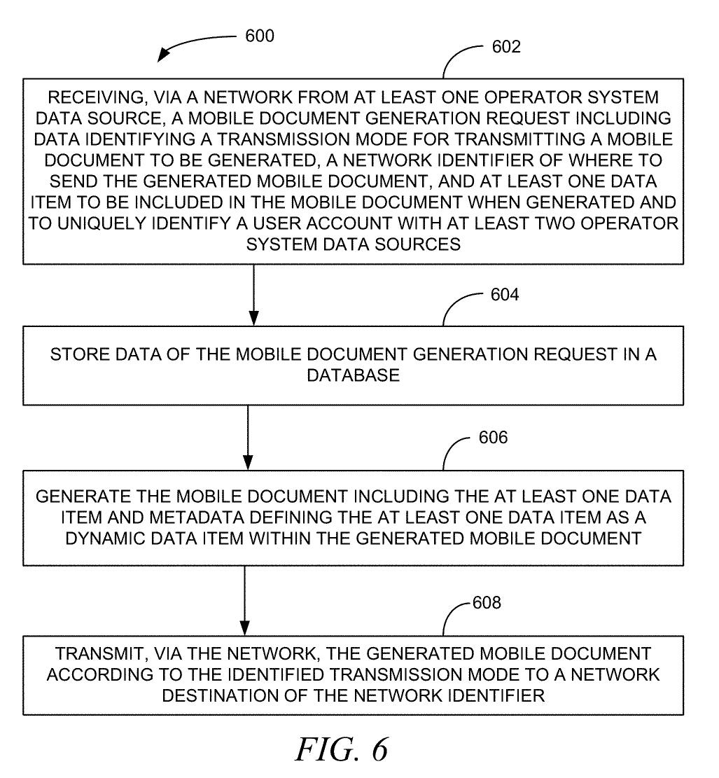

FIG. 6 is a block flow diagram of a method 600, according to an example embodiment. The method 600 is an example of a method that may be performed as part of a mobile document generation. service as referred to with regard to the method 500 of FIG. 5 and may be performed on the cloud service provider system 214 of FIG. 2 in some embodiments.

The method 600 includes receiving 602, via a network from at least one operator system data source, a mobile document generation request. The operator system may be one of the operator systems 212A, 212B illustrated and described with regard to FIG. 2. A mobile document generation request typically includes data identifying a transmission mode for transmitting a mobile document to be generated, a network identifier of where to send the generated mobile document, and at least one data item to be included in the mobile document when generated and to uniquely identify a user account with at least two operator system data sources. The method 600 then stores 604 data of the mobile document generation request in a database and generates 606 the mobile document including the at least one data item and metadata defining the at least one data item as a dynamic data item within the generated mobile document. The method 600 then proceeds to transmit 608, via the network, the generated mobile document according to the identified transmission mode to a network destination of the network identifier.

In some embodiments of the method 600, the data identifying the transmission mode identifies at least one of a text message or email that includes a Uniform Resource Identifier from which the mobile document may be retrieved, a mobile device in-app message that includes the mobile document or a URI from which an app will retrieve the mobile document, an email that includes the mobile document therein or as an attachment. Regardless of the transmission mode, the mobile document is viewable within at least one of a mobile wallet app, a mobile app, a web browser, an image viewing app, and a document viewing app.

Within some embodiments of the method 600, at least two operator systems of the at least two operator system data sources include at least two of a retailer, a restaurant, an event host, and a service provider. The token in such embodiments uniquely identifies the user account with each of the at least two of the retailer, the restaurant, the event host, and the service provider, although this may be a single token known to each of the at least two operator systems. Regardless this token may be included in the mobile document as one or both of a barcode and a data item to be provided by a mobile device storing the mobile document at any of the at least two operator systems within a Near-Field Communication (NFC) or BLUETOOTH® transmission.

The token, in some embodiments of the method 600, is a token that can be included in a single mobile document and used in multiple transactions with a single operator system. In some embodiments, the token may even be used in multiple transactions across two or more operator systems.

In a further embodiment, the method 600 includes receiving transaction data from any of the at least two operator system data sources and the transaction data includes a data representation of the token. The method 600 in such embodiments then stores the transaction data in the database in association with the user account of the token. Some such embodiments further include identifying a recommendation based on the received transaction data and other data of the user account associated with the token. This recommendation may be formed logically based on data of the user and other users as well as paid promotions, promotions, popular offerings at certain times of the day or a current time of year as well as transaction history of the user and other users with one or more retailers and service providers regarding purchase history, events attended, actors of likely interest, and the like. Such embodiments, once one or more recommendations are identified, then generates a mobile document update based on the identified recommendation and transmits, via the network, the generated mobile document update according to the identified transmission mode to a network destination of the network identifier.

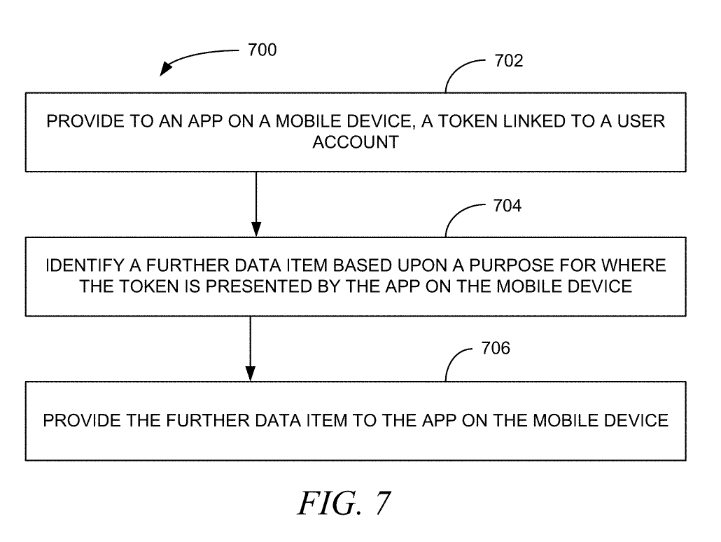

FIG. 7 is a block flow diagram of a method 700, according to an example embodiment. The method 700 is an example of a method that may be performed by one or a combination of the cloud service provider system 214 and operator systems 212A, 212B of FIG. 2, in some embodiments. The method 700 is an example of a method that may be performed to identify further data or recommendations to provide to a user of a mobile document based on how or where the mobile document has been presented.

The method 700 includes providing 702 to an app on a mobile device, a token linked to a user account, such as in response to a request from the mobile device app for a token, a request for a mobile document including a token, and the like. The method 700 further includes identifying 704 a further data item based upon a purpose for where the token is presented by the app on the mobile device. For example, the purpose may be to purchase a movie ticket and the further data item identified 704 may be one or more coupons, other promotions, recommendations, and the like for concession items, further movie tickets, merchandise offered for sale that is associated with the movie of the movie ticket, and the like. In some embodiments, the further data item may be or include a restaurant recommendation or selectable (i.e., hyperlinked) reservation option. The method 700 additionally includes providing 706 the further data item to the app on the mobile device.

In some embodiments of the method 700, the purpose for which the mobile barcode was presented is a transaction type, such as a fuel purchase, a concert ticket purchase, an air travel purchase, among other purposes. The further data item in such embodiment may be identified based on a stored association of the further data item to the transaction type, such as a coupon for an oil change associated with a fuel purchase transaction purpose. Thus, the transaction type may be a purchase from a particular retailer, service provider, or venue and the further data item may include at least one of a promotion, a recommendation, a coupon, that is relevant to at least one of the particular retailer, service provider, venue, or a product or service purchased therefrom.

In some further embodiments of the method 700, the token is encoded within data of a mobile document provided to the app on the mobile device. Further, the token may be encoded within data of the mobile document as a barcode image to be presented by the app on a display of the mobile device. Alternatively in other embodiments, the token is encoded within data of a mobile document for provisioning in a short-range radio signal by the mobile device, such as may be transmitted by NFC, BLUETOOTH®, and the like. Regardless of how encoded or how it is to be presented, the token in some embodiments is available for presentment within a plurality of transactions by the app on the mobile device,

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

What is claimed is:

1. A system comprising:
at least one computer processor;
at least one memory device;
at least one network interface device;
a database under management by a database management system stored on the at least one memory device or accessible via that at least one network interface device, the database storing mobile document data received from or for provision to at least two sources;
a mobile document generation module stored in the at least one memory device and executable by the at least one processor to perform data processing activities comprising:
receiving, via the at least one network interface device from one of the at least two sources, a mobile document generation request including at least one data item to be included in the mobile document when generated and to uniquely identify a user account with at least one of the at least two sources;
generating the mobile document including the at least one data item; and
transmitting, via the at least network interface device, the generated mobile document

2. The system of claim 1, wherein:
receiving the mobile document generation request includes receiving a network identifier of where to send the generated mobile document; and
transmitting the generated mobile document includes transmitting the generated mobile document according to the network identifier.

3. A method comprising:
generating a mobile document having a token that uniquely identifies a user account; and
transmitting the mobile document to a requestor for conducting at least two transactions with at least one entity through the token.

4. The method of claim 3, wherein:
the at least one entity includes at least two of a retailer, a restaurant, an event host, and a service provider; and
the token uniquely identifies the user account at each of the at least two of the retailer, the restaurant, the event host, and the service provider.

5. The method of claim 3, wherein the token is included in the mobile document as a barcode.

6. The method of claim 3, wherein the token is to be provided by the requestor to an entity of the at least one entity within a Near-Field Communication (NFC) or BLUETOOTH® transmission.

7. The method of claim 3, wherein generating and transmitting the mobile document includes:
transmitting, via a network, the data retrieved from the database including data indicating how the mobile document is to be provided to the requestor by a mobile document generation service, the mobile document generation service to generate and transmit the mobile document to the requestor.

8. The method of claim 7, further comprising:
receiving, via the network from the requestor, a mobile document data update request including at least the token;
retrieving at least a portion of the data for the mobile document from the database; and
transmitting, via the network, at least the portion of the retrieved data for the mobile document to the mobile document generation service to provide to the mobile device.

9. The method of claim 3, wherein the requestor is a mobile device and the mobile document is viewable within at least one of a mobile wallet app, a mobile app, a web browser, an image viewing app, and a document viewing app of the requestor.

10. The method of claim 9, wherein the mobile document includes:
an event ticket portion identifying an event venue, event date, and event start time; and
the event ticket portion to be presented at the venue via the token to gain entry to the venue for the event.

11. The method of claim 10, wherein the event venue, event date, and event start time are subject to change, the method further comprising:
receiving, via a network from the mobile device, a mobile document data update request including at least the token;
retrieving any updates to the event venue, event date, and event start time for the mobile document from the database; and
transmitting, via the network to the mobile device, at least the portion of the retrieved data for the mobile document to update the mobile document on the mobile device.

12. The method of claim 10, wherein the mobile document further includes a recommendation portion providing recommendations of one or more other events, restaurants, products, and promotions, the recommendation portion populated by a recommendation process with data of at least one of promotional data, sponsored recommendations, recommendations determined based on historic data stored in association with the user account, and proximity of restaurants and other outlets to the venue.

13. A method comprising:
providing to an app on a mobile device, a token linked to a user account;
identifying data based upon a purpose for which the token is presented by the app on the mobile device.

14. The method of claim 13, wherein:
the purpose for which the mobile barcode was presented is a transaction type; and
the identified data item is identified based on a stored association of the further data item to the transaction type.

15. The method of claim 14, wherein the transaction type is a purchase from a particular retailer, service provider, or venue and the further data item includes at least one of a promotion, a recommendation, a coupon, that is relevant to at least one of the particular retailer, service provider, venue, or a product or service purchased therefrom.

16. The method of claim 15. wherein the token is encoded within data of a mobile document provided to the app on the mobile device.

17. The method of claim 16, wherein the token is encoded within data of the mobile document as a barcode image to be presented by the app on a display of the mobile device.

18. The method of claim 16, wherein the token is encoded within data of a mobile document for provisioning in a short-range radio signal by the mobile device.

19. The method of claim 13, wherein the token is available for presentment within a plurality of transactions by the app on the mobile device.

20. The method of claim 13, wherein the method is performed at least in part by a third-party cloud service provider for at least one retailer, service provider, and venue entities.
